(19) United States
(12) Patent Application Publication
(10) Pub. No.: US 2023/0331287 A1
(43) Pub. Date: Oct. 19, 2023

(54) PROGRESSIVE STEERING GEAR, SERRATED COMPONENT, AND MANUFACTURING METHODS

(71) Applicant: Werner BLESS, Ruti (CH)

(72) Inventor: Werner BLESS, Ruti (CH)

(21) Appl. No.: 18/016,763

(22) PCT Filed: Jul. 19, 2021
(86) PCT No.: PCT/EP2021/070184

§ 371 Date: Jan. 18, 2023

(30) Foreign Application Priority Data
Jul. 20, 2020 (DE) 10 2020 119 089.1

(51) Int. Cl. B62D 3/12; B62D 5/04

(52) U.S. Cl. CPC B62D 3/126; B62D 5/0442; B62D 5/0421

(57) ABSTRACT

A serrated component (10) for use in a progressive steering gear includes first and second inclined prong ramps (14, 16). The first and second inclined prong ramps (14, 16) include a plurality of prongs (20, 50) each having a first flank angle and a second flank angle with respect to a center plane (48) that extends normal to a longitudinal direction (34) of the serrated component (10). For at least 50% of the prongs (20, 50) of the plurality of prongs (20, 50), the first flank angles have a single first angle value and the second flank angles have a single second angle value, the first angle value corresponding to a reflection of the second angle value at the center plane (48). The invention further comprises a progressive steering gear, a method of manufacturing a serrated component, and a method of manufacturing a steering gear.

The invention relates in general to the technical field of vehicle steering systems and in particular to the field of progressive steering systems and/or rack-and-pinion steering systems.

Progressive steering systems are well known in a wide variety of configurations. For example, WO 2006/079492 A1 shows various embodiments of a progressive steering gear. According to one embodiment, which has proved particularly advantageous in practice, a progressive steering gear has three inclined racks located in different planes and three associated spur gears. In steering positions on one side of a center position, the center spur gear engages the center rack, while in steering positions on the other side of the center position, the two outer spur gears engage the two outer racks.

The embodiment according to WO 2006/079492 A1, as briefly described above, has already proved very advantageous in practice. In the course of extensive work and testing, however, further improvements have been found, particularly regarding, but not limited to, a particularly harmonious driving experience and/or cost-effective manufacture. These improvements are the subject of the present document.

The invention is defined by the independent claims. The dependent claims concern optional features of some embodiments of the invention.

A first aspect of the invention relates to a serrated component for use in a progressive steering gear, comprising first and second inclined prong ramps having a plurality of prongs each having a first flank angle and a second flank angle with respect to a center plane that runs normal to a longitudinal direction of the serrated component. For at least 50% of the prongs, the first flank angles have a single first angular value, and the second flank angles have a single second angular value, the first angular value corresponding to a reflection of the second angular value at the center plane.

It was found that the use of prongs according to the invention, instead of the teeth commonly used in rack-and-pinion steering systems, offers considerable advantages. The uniform flank angles, which are symmetrical with respect to the center plane, result in a particularly harmonious and secure steering experience and/or allow relatively inexpensive manufacture. These results are surprising because they run counter to the calculations and optimizations of tooth geometries carried out over many decades, particularly in the field of rack-and-pinion steering systems.

Further aspects of the invention relate to a progressive steering gear, a method of manufacturing a serrated component, and a method of manufacturing a steering gear.

Further features, advantages and objects of the invention will be apparent from the accompanying schematic drawings of multiple sample embodiments. The drawings show:

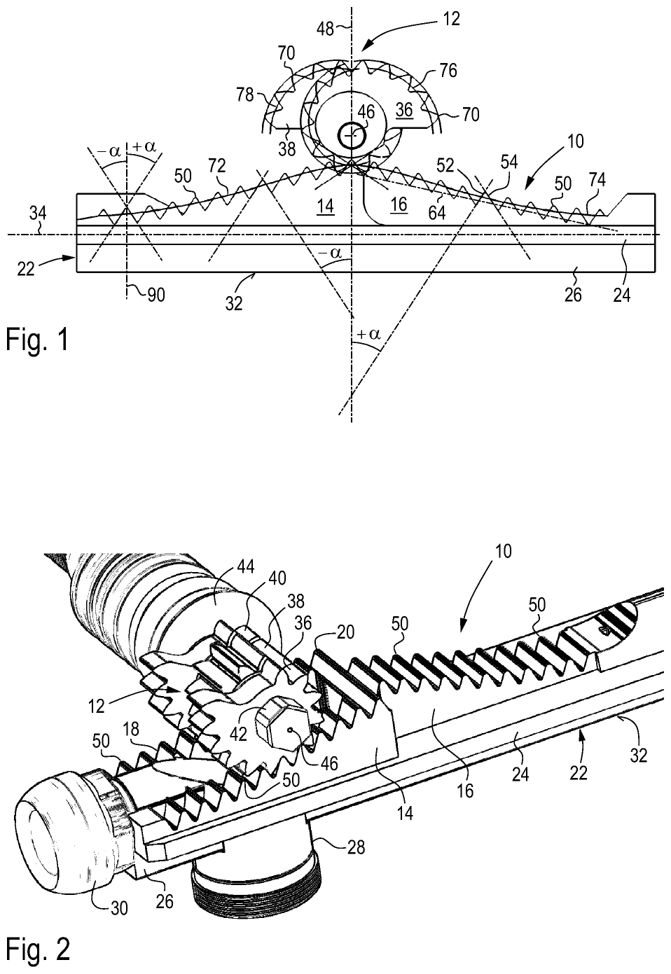

FIG. 1 a side view of a serrated component and a pinion component according to a first sample embodiment of the invention,

FIG. 2 a perspective view of components of a progressive steering gear according to a second sample embodiment of the invention, which differs only slightly from the first sample embodiment shown in FIG. 1,

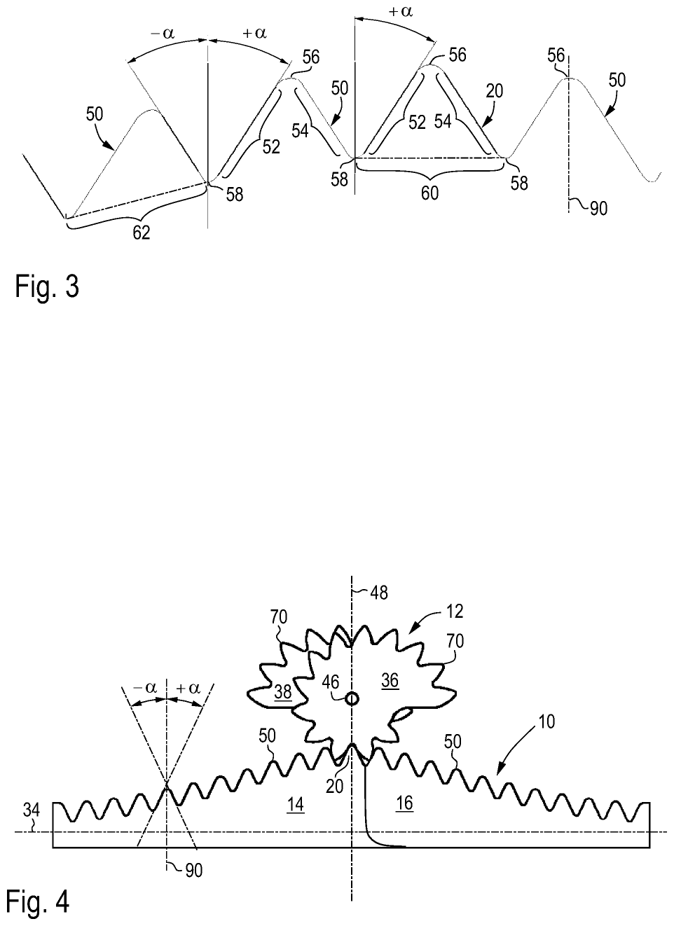

FIG. 3 an enlarged view of the prong geometry in the first and second sample embodiments,

FIG. 4 a side view similar to FIG. 1 in a third sample embodiment with steeper flank angles of the prongs,

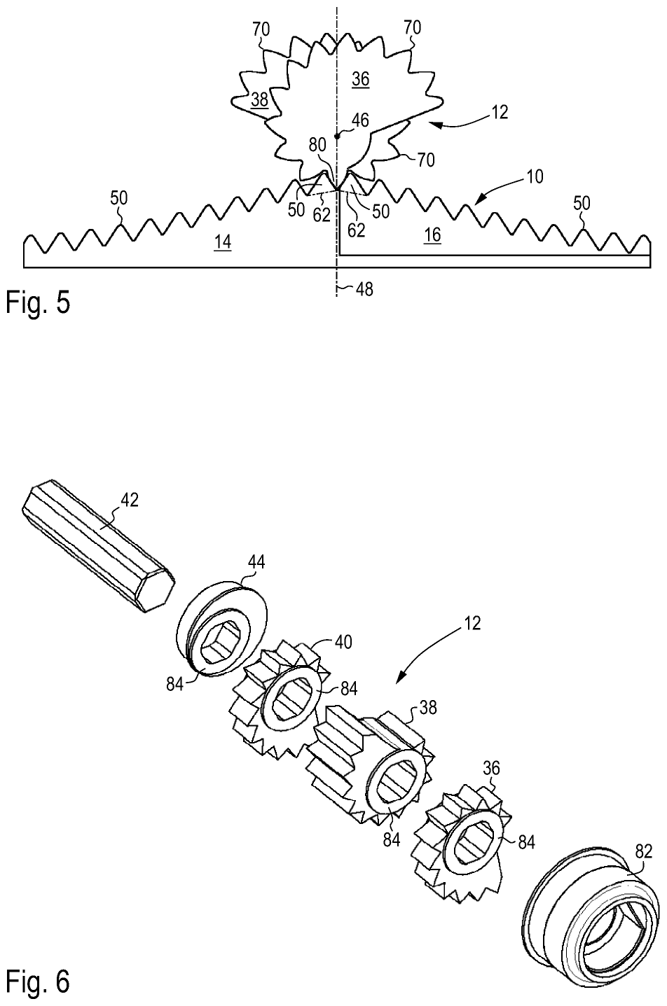

FIG. 5 a side view similar to FIG. 1 in a fourth sample embodiment in which the serrated component has no center prong,

FIG. 6 an exploded view of a pinion component and associated components in a further sample embodiment,

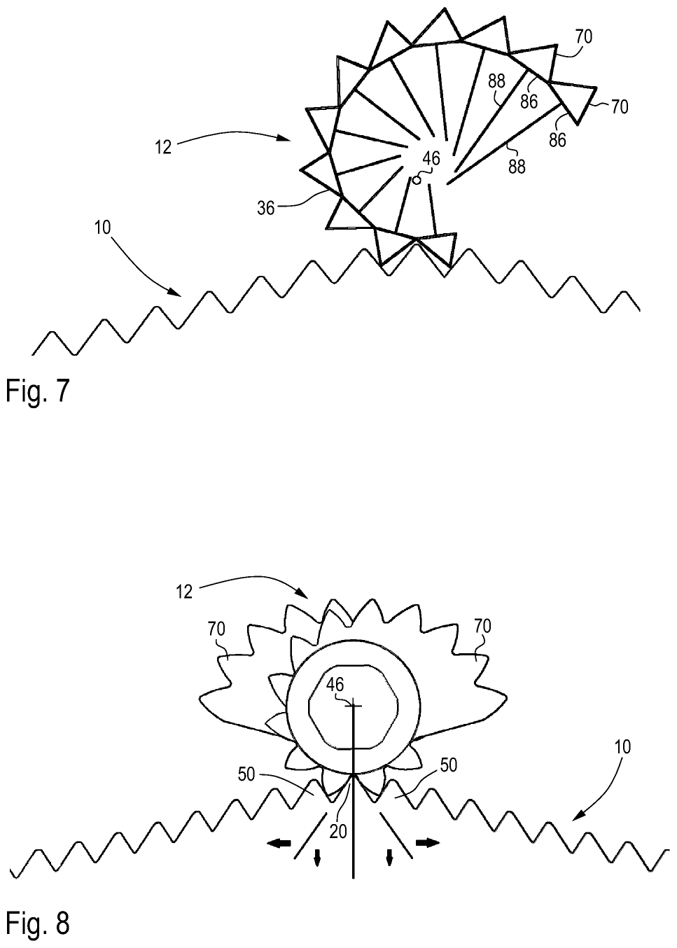

FIG. 7 a schematic diagram illustrating the design of a pinion element,

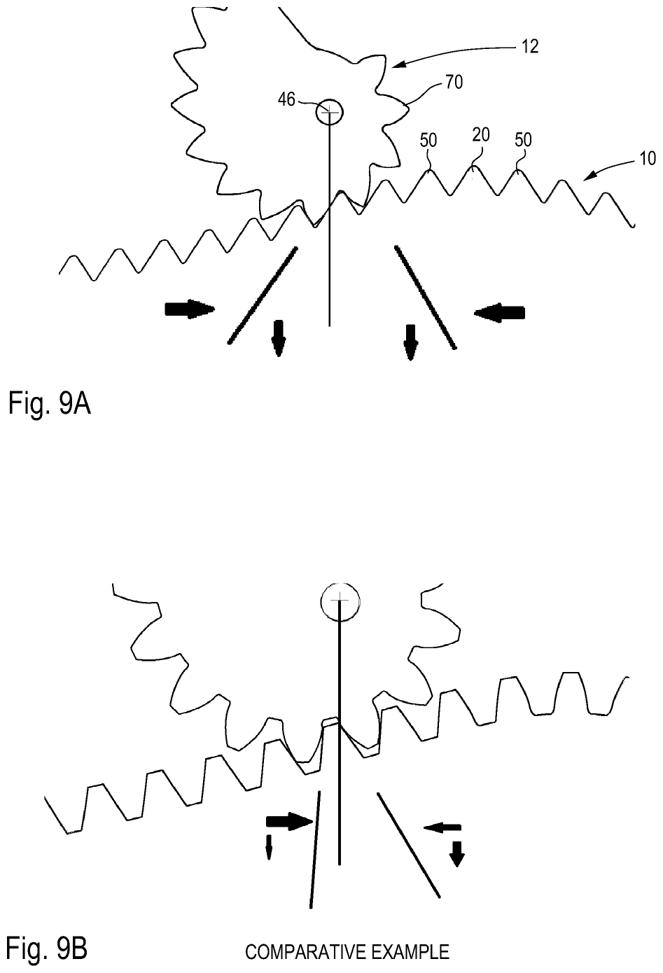

FIG. 8 and FIG. 9A each an enlarged side view to illustrate the rolling behavior in the first and second sample embodiments, respectively,

FIG. 9B an enlarged side view similar to FIG. 9A in a comparative example,

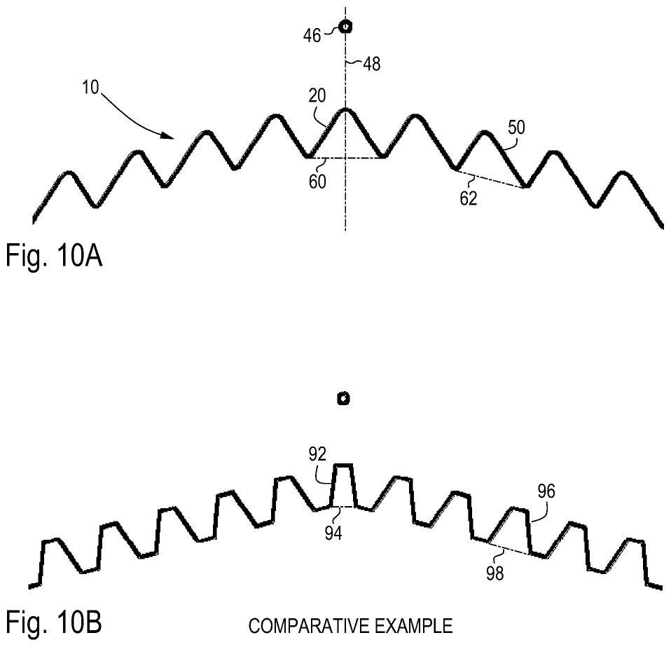

FIG. 10A a schematic side view in the first and second sample embodiments of the invention,

FIG. 10B a schematic side view of a rack in a comparative example, the scale being similar as in FIG. 10A,

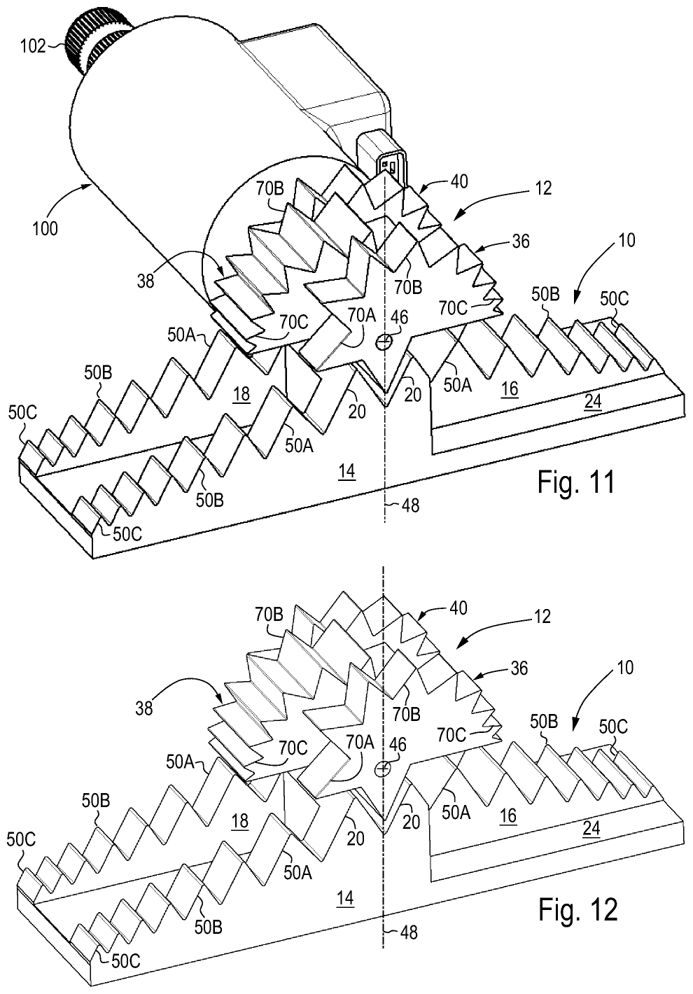

FIG. 11 a perspective view of a steering gear according to a further sample embodiment of the invention, and

FIG. 12 a perspective view as in FIG. 11, wherein only the serrated component and the pinion component are shown.

A progressive steering gear according to the embodiments shown as examples in the drawing figures comprises a serrated component 10 and a pinion component 12. The serrated component 10 includes a first, a second and a third prong ramp 14, 16, 18, which are arranged in three planes arranged one behind the other in the lateral viewing direction onto the component 10 according to FIG. 1. The first prong ramp 14 is visible on the left in FIG. 1. The second prong ramp 16 is mostly visible on the right in FIG. 1, namely except for a center prong 20 (FIG. 2) where the first and second prong ramps 14, 16 overlap. The third prong ramp 18 is partially visible in FIG. 2, but in FIG. 1 is completely obscured by the first prong ramp 14, which, in the side view of FIG. 1, has identical contours to the third prong ramp 18 and is located exactly in front of it.

While the sample embodiments shown in FIG. 1 and FIG. 2 include a center prong 20 common to all three prong ramps 14, 16, 18, embodiments are also envisaged in which the second prong ramp 16 does not overlap with the first and third prong ramps 14, 18, as well as embodiments in which the overlap extends over several center prongs—for example, two or three prongs.

In the present sample embodiment, the prong ramps 14, 16, 18 are integrally formed with a base 22 having side portions 24 and a lower support portion 26. The support portion 26 may have, for example, a rectangular or dovetailed cross-section. In the sample embodiment shown in FIG. 2, the support portion 26 is guided and pressed against the pinion component 12 by a spring-loaded pressure element 28. For example, the pressure element 28 can provide a spring travel of at least 0.1 mm or at least 0.2 mm. The steering gear is designed in such a way that the serrated component 10 is adapted to move by this spring travel relative to the pinion component 12. On both sides, the serrated component 10 has respective connection means—e.g. a screw thread each—for connecting to a respective joint member of a steering track rod; FIG. 2 shows an example of such a joint member 30.

In some embodiments, no further guidance of the serrated component 10—apart from the guidance provided by the steering track rods, the pressure element 28 and the pinion component 12—is provided in a housing (not shown in the figures) of the steering gear. In other sample embodiments, however, the side portions 24 additionally serve to guide the serrated component 10 in the housing of the steering gear. Such steering gears with a serrated component 10 guided by the side portions 24 are particularly stable.

In the sample embodiments described herein, an underside of the support portion 26—and thus the base 22—forms a flat base plane 32 that extends in parallel to a longitudinal direction 34 of the serrated component 10. Thus, both the longitudinal direction 34 and the base plane 32 extend in the direction in which the serrated component 10 is shifted back and forth during steering movements.

Corresponding to the serrated component 10 with its prong ramps 14, 16, 18 arranged in three planes, the pinion component 12 has a first, a second and a third pinion element 36, 38, 40 located in the same three planes. The three pinion elements 36, 38, 40 are arranged rigidly with respect to each other and rotationally fixed on a steering shaft end member 42, which in turn is supported in a steering shaft bearing 44. The steering shaft end member 42 together with the pinion component 12 located thereon is coupled in a manner known as such to a steering wheel (not shown) via several sections of a steering shaft and/or steering column (not shown), so that steering movements cause a corresponding rotation of the pinion component 12. Here, both the steering shaft end member 42 and the three pinion elements 36, 38, 40 rotate about a common axis of rotation 46.

In the sample embodiments described herein, the first pinion element 36 has an outline identical to the third pinion element 40 in the side view of FIG. 1, so that the first pinion element 36 exactly covers the third pinion element 40. The second pinion element 38 is formed approximately or exactly mirror-symmetrical relative to the first and third pinion elements 36, 40. Further, in the sample embodiments described herein, the first pinion element 36 is as thick as the third pinion element but only half as thick as the second pinion element 38. Correspondingly, the first prong ramp 14 is as thick as the third prong ramp 18 but only half as thick as the second prong ramp 16.

The first pinion element 36 is adapted to be in engagement with the first prong ramp 14 in steering positions in which a steering wheel is turned clockwise relative to the center position from the driver's perspective—as is the case, for example, in FIG. 2. When the steering wheel is then turned counterclockwise, the serrated component 10 moves to the left in the orientation shown in FIG. 2 until the first serrated element 26 comes out of engagement with the first prong ramp 14 and rotates freely in the empty space to the right of the first prong ramp 14. This shifting of the serrated component 10 in its longitudinal direction 34 is converted into a corresponding steering movement of the vehicle wheels; the direction of the steering movement (i.e., whether the vehicle wheels turn to the right or to the left in the direction of travel) depends on the installation position of the steering gear.

The third pinion element 40 and the third prong ramp 18 behave in the same way as the first pinion element 36 and the first prong ramp 14. The second pinion element 38, on the other hand, rotates freely in the position shown in FIG. 2 and, when the steering wheel is turned counterclockwise from this position, comes into engagement with the second prong ramp 16 from approximately the middle position of the steering wheel, namely first with the middle prong 20 and then with the prongs shown further to the right in FIG. 2.

The prong ramps 14, 16, 18 are each inclined, namely the second prong ramp 16 in opposite orientation to the first and third prong ramps 14, 18. A center plane 48 is arranged normal to the base plane 32 and the longitudinal direction 34. In the embodiments described herein, the center plane 48 forms a plane of symmetry with respect to the general inclination of the prong ramps 14, 16, 18. In some embodiments, the center plane 48 represents an exact plane of symmetry. However, embodiments are also envisaged in which the prong ramps 14, 16, 18 are not fully mirror symmetrical with respect to each other and thus the center plane 48 is only approximately a plane of symmetry. In some embodiments, a center prong 20 is provided, and the center plane 48 extends through a tip of this center prong 20. Further, in some embodiments, the center plane 48 extends through the axis of rotation 46 of the pinion component 12 when the steering gear is in a center position.

In addition to the center prong 20, each of the three prong ramps 14, 16, 18 comprises a plurality of further prongs, some of which are denoted by the reference sign 50 in the drawing figures. For example, in addition to the center prong 20, each of the three prong ramps 14, 16, 18 may include approximately ten further prongs 50, more generally between seven and thirteen further prongs 50. Each prong 20, 50 has, as shown in FIG. 3, an approximately rectilinear first flank 52 and an approximately rectilinear second flank 54 between which a rounded tip 56 is formed. A rounded valley 58 is respectively formed between a first flank 52 of a first prong 20, 50 and an adjacent second flank 54 of an adjacent second prong 20, 50. A prong base 60, 62 respectively extends between two valleys 58 of a prong 20, 50. In the case of the center prong 20, the rectilinear first and second flanks 52, 54 are of equal length, and the prong base 60 extends horizontally, i.e., parallel to the base plane 32 and the longitudinal direction 34. In the case of prongs 50 which differ from the center prong 20, the rectilinear first and second flanks 52, 56 are of different lengths, depending on the slope of the prong base 62 relative to the base plane 32 and the longitudinal direction 34.

For example, an inclination plane 64 averaged over the longitudinal extent of a prong ramp 14, 16, 18, as exemplified in FIG. 1 for the prong ramp 16, may have an angle of about 15° relative to the base plane 32 and the longitudinal direction 34, or more generally an angle of between 8° and 25°, or an angle of between 10° and 20°. The angle of the inclination plane 64 corresponds to the averaged angle of the associated prong bases 62. However, local variations may be present because in many embodiments the prong ramps 14, 16, 18 are not inclined in a straight line but include local corrections. These corrections may serve, for example, to compensate for a running gear progression and/or a Cardan joint error.

Each first flank 52 of a prong 20, 50 forms a first flank angle with respect to the center plane 48, and each second flank 54 forms a second flank angle with respect to the center plane 48. An important characteristic of the prongs 20, 50 provided according to the invention is that, at least for a major part of the total number of prongs 20, 50, all first flank angles have a single first angular value +α, and all second flank angles have a single second angular value −α corresponding to a reflection of the first angular value +α at the center plane 48. For example, in the sample embodiment shown in FIG. 1, for each prong 20, 50 shown, the first angular value is +33°, and the second angular value is correspondingly −33°, each with a permissible deviation of ±10% or ±5% or ±2%.

The property that the first and second flank angles have angular values of +α and −α, respectively, applies in various embodiments to at least 50% of the prongs 20, 50, or to at least 70% of the prongs 20, 50, or to at least 80% of the prongs 20, 50, or to at least 90% of the prongs 20, 50, or to all of the prongs 20, 50. Furthermore, embodiments are envisaged in which said percentages refer only to those prongs 50 which have a respective prong base 62 inclined relative to the base plane 32 and the longitudinal direction 34. In other words, in these embodiments, the center prong 20 and any other prongs having a prong base parallel to the base plane 32 are not taken into account in the calculation of the percentages.

The first and second angular values may be selected differently in different embodiments, but with the same absolute amounts for each embodiment. For example, FIG. 4 shows a sample embodiment with steeper prong flanks 52, 54, in which the first angle value is +25° for each prong 20, 50 shown, and the second angle value is −25°, in each case with a permissible deviation of ±10% or ±5% or ±2%. This embodiment has the advantage that a larger radius of curvature can be selected for the tips 56 and valleys 58 of the prongs 20, 50. It is understood that in further embodiments further first and second angle values are possible, for example ±25°±5% or ±30°±10% or ±30°±5% or ±33°±5% or ±35°±10% or ±35°±5%.

The pinion elements 36, 38, 40 also have prongs, some of which are denoted by reference sign 70 in the drawing figures. The prongs 70 are arranged and shaped so that they engage the prongs 20, 50 of the prong ramps 14, 16, 18 and provide a harmonic rolling motion. For example, the prongs 70 can have curved flanks in the sense of an involute toothing or a cycloid toothing. This results in a first rolling curve 72 at the first prong ramp 14 shown on the left in FIG. 1, a second rolling curve 74 at the second prong ramp 16 shown on the right in FIG. 1, and corresponding third and fourth rolling curves 76, 78 at the first and second pinion elements 36, 38, respectively. Averaged over the length of the first and second prong ramps 14, 16, the course of the first and second rolling curves 72, 74 respectively follows the inclination of the corresponding prong ramp 14, 16, as illustrated, for example, by the inclination plane 64.

In the embodiments described herein, the pressure element 28 is spring-loaded and provides a relatively large spring travel of, for example, 0.1 mm or 0.2 mm. There is therefore considerable margin for manufacturing tolerances and/or deliberate deviations to optimize the steering behavior.

As already mentioned, embodiments are also envisaged in which the serrated component 10 does not have any center prong 20. FIG. 5 shows a corresponding sample embodiment. Here, the first and second prong ramps 14, 16 terminate to the left and right of the center plane 48, respectively, with a prong 50 that does not represent a center prong 20 because it has an inclined prong base 62. In contrast, the pinion component 12 has a center prong 80 which is formed in all three pinion elements 36, 38, 40 and which, in the center position of the steering gear, as shown in FIG. 5, extends symmetrically with respect to the center plane 48 and engages between the two above-mentioned prongs 50 on the left and right of the center plane 48.

In the sample embodiment shown in FIG. 5, the prong 50 adjacent to the left of the center plane 48 is formed only in the first prong ramp 14 (as well as in the third prong ramp 18, which is not visible in FIG. 5). Accordingly, the prong 50 adjacent to the right of the center plane 48 is formed only in the second prong ramp 16. However, embodiments are also envisaged in which the two above-mentioned prongs 50 are formed across all three prong ramps 14, 16, 18, so that the prong ramps 14, 16, 18 overlap in the region of these two prongs 50.

The exploded view of the pinion component 12 in FIG. 6 illustrates the use of a steering shaft end member 42 with a non-circular transverse section onto which the three pinion elements 36, 38, 40 are pressed and thus held in the desired angular position relative to one another. One bearing each, namely the steering shaft bearing 44 and a further bearing 82, are provided on both sides of the package formed by the three pinion elements 36, 38, 40. Spacers 84 provide a desired distance between the pinion elements 36, 38, 40, in order to ensure a desired clearance between the pinion elements 36, 38, 40 and the prong ramps 14, 16, 18 and, for example, to prevent the second pinion element 38 from rubbing laterally against one of the two prong ramps 14, 18. In the sample embodiment shown in FIG. 6, the spacers 84 are formed as projections or thickenings on the pinion elements 36, 38, 40 and the bearings 44, 82. However, embodiments are also envisaged in which separate shims or other components, similar to washers, serve as spacers 84.

FIG. 7 illustrates an example of the design of a pinion element, e.g., the first pinion element 36. Each prong 70 has a prong base 86 whose inclination corresponds approximately to the inclination of the rolling curve 76 (FIG. 1) at the respective prong 70. A respective normal 88 to each prong base 86 does not pass through the axis of rotation 46, but passes laterally therefrom.

The steering gear described herein has a progressive transmission ratio characteristic. In a center position of the steering gear, the steering permits sensitive steering movements because the distance between the axis of rotation 46 of the pinion component 12 and the pitch point between the rolling curves 72, 74, 76, 78 is small. With increasing steering deflection, the distance between the axis of rotation 46 and the pitch point becomes greater and greater, so that relatively small movements of the steering wheel lead to relatively large shifting displacements of the serrated component 10. This is particularly useful for maneuvering and parking operations.

In some embodiments, it is envisaged that the rolling curves 72, 74 of the serrated component 10 are rectilinear (but inclined), and the rolling curves 76, 78 of the pinion component 12 are spiraled. The transmission ratio of the steering gear then changes in proportion to the angle by which the pinion component 12 is rotated relative to its center position (FIG. 1). In practical testing, however, it has been found that it can be advantageous to take into account deviations caused, for example, by the Cardan error of a Cardan joint in the steering shaft and/or by the running gear progression of a vehicle. Therefore, embodiments are also envisaged—as shown, for example, in the drawing figures—in which such deviations are corrected by means of non-rectilinear rolling curves 72, 74 of the serrated component 10. Depending on the nature of the deviations to be corrected, the non-rectilinear rolling curves 72, 74 may be mirror-symmetrical or non-symmetrical with respect to each other. The rolling curves 76, 78 of the pinion component 12 are adapted accordingly.

The geometry of the serrated component 10 described herein differs in particular from the embodiments known from WO 2006/079492 A1 in that, at least for a majority of the prongs 20, 50, an angle bisector 90 of the respective prong 20, 50 runs parallel to the center plane 48, i.e., perpendicular to the longitudinal direction 34 and/or the base plane 32. This applies at least to a majority of those prongs 50 whose prong base 62 is inclined with respect to the longitudinal direction 34 and/or the base plane 32. In contrast, in the embodiments known from WO 2006/079492 A1, the angle bisectors of all teeth are perpendicular to the respective tangents of the rolling curve at the respective tooth.

The design according to the invention enables a particularly harmonious and safe driving and steering experience. This is due in particular to the fact that counterforces caused, for example, by restoring forces of the running gear or by road influences, which can occur in both directions, are fed back evenly to the steering wheel. This is illustrated for the center position of the steering in FIG. 8 and for a turned position in FIG. 9A. FIG. 9B shows the turned position as in FIG. 9A for a comparative example having a known tooth form of a rack and a pinion, in which for each tooth an angle bisector of the tooth flanks is aligned normal to the base of the tooth. In the comparative example shown in FIG. 9B, the counterforces are fed back to the steering wheel unevenly depending on the direction of the counterforce, as shown by the horizontal arrows in FIG. 9B. In contrast, according to FIG. 8 and FIG. 9A, the forces shown by the horizontal arrows, which are coupled back to the steering wheel, are independent of the direction in which these forces act.

The same applies to the portion of the counterforces that are coupled into the pressure element 28, as shown by the vertical arrows in FIG. 8, FIG. 9A and FIG. 9B. Since the pressure element 28 is spring-loaded and provides a relatively large spring travel of e.g. 0.2 mm, each force coupling into the pressure element 28 changes the steering experience. It is therefore advantageous if the proportion of forces coupled into the pressure element 28 is independent of whether these forces push the serrated component 10 to the right or to the left.

All in all, thanks to the uniform flank load, disturbing fluctuations between a steering force and a counterforce (e.g. restoring force) are balanced out. This results in a more harmonious and safer steering and driving experience with particularly good steering feedback.

A further advantage in some embodiments of the invention is that the prong geometry described herein allows for an at least normally strong or even reinforced center prong 20. This is shown in FIG. 10A, according to which the prong base 60 of the center prong 20 is at least as long as the prong base 62 of a side prong 50—and in the sample embodiment of FIG. 10A even slightly longer. This increases the stability of the heavily stressed center prong 20 and thus represents a further considerable advantage of the embodiments described herein.

FIG. 10B shows a comparative example with a tooth form of a rack known as such, in which a tooth base 94 of a center tooth 92 is significantly shorter than a tooth base 98 of a side tooth 96. Thus, in this comparative example, the center tooth 92 is significantly weaker than the side teeth 96.

FIG. 11 and FIG. 12 show another sample embodiment of a steering gear in which two changes have been made with respect to the previously described sample embodiments. These two changes are, first, that the steering gear has a motor 100 with a motor shaft connected to the pinion component 12 in a rotationally fixed manner or via a gear, and second, that prongs 50A, 50B, 50C, 70A, 70B, 70C of different sizes are provided in the serrated component 10 and the pinion component 12. The two above-mentioned modifications advantageously work together, but each can also be used on its own. The disclosure content of the present document therefore also includes embodiments as described so far (FIGS. 1-12), which are modified in such a way that they comprise only the motor 100, or only the prongs 50A, 50B, 50C, 70A, 70B, 70C of different sizes, or both.

Already shown in FIG. 10A was an embodiment in which the center prong 20 has a longer prong base 60 than the prong base 62 of the other prongs 50. In the serrated component 10 according to FIG. 11 and FIG. 12, however, the prongs 50A, 50B, 50C are also dimensioned differently, i.e., for example, they have prong bases of different lengths and/or they have different prong heights. In the embodiment according to FIG. 11 and FIG. 12, the prongs 50A adjacent to the center prongs 20 on both sides are the largest ones, and the prongs 50C at both ends of the serrated component 10 are the smallest ones. The size of the intervening prongs 50B decreases uniformly or in a stepwise fashion as the distance from the center plane 48 increases.

In other embodiments, however, the size progression of the prongs 50A, 50B, 50C is opposite to that shown in FIG. 11 and FIG. 12, such that the prongs 50A (and one or more center prongs 20, if any) are smallest, the prongs 50C are largest at the ends of serrated component 10, and intervening prongs 50B increase in size uniformly or in a stepwise fashion as the distance from the center plane 48 increases. Other size gradients are also provided in further embodiments. This includes, but is not limited to, size gradients in which the intermediate prongs 50B are larger than both the near-center prongs 50A and the outer prongs 50C, and size gradients in which the intermediate prongs 50B are smaller than both the near-center prongs 50A and the outer prongs 50C.

Except for the different sizes, the center prongs 20 and the prongs 50A, 50B, 50C have the characteristics of the sample embodiments described so far. In particular, also in the sample embodiment example according to FIG. 11 and FIG. 12, the flank angles of all prongs 50A, 50B, 50C are the same or mirrored at the center plane 48. It is understood that in all embodiments described herein, optionally one center prong 20 (as shown in FIG. 1) or two center prongs 20 (as shown in FIG. 11 and FIG. 12) or no center prong common to the prong ramps 14, 16, 18 (as shown in FIG. 5) can be provided.

The prongs 70A, 70B, 70C of the pinion elements 36, 38, 40 are each shaped to correspond to the prongs 50A, 50B, 50C of the prong ramps 14, 16, 18 and are therefore also formed in different sizes.

The motor 100 for steering power assistance further shown in FIG. 11 is designed, for example, as a gearless electric motor whose motor shaft is connected to the pinion component 12 in a rotationally fixed manner. In the example embodiment shown in FIG. 11, the motor shaft is integrated in the steering shaft and forms a section of the steering shaft; a steering shaft attachment member 102 is shown in FIG. 11. In other words, this section of the steering shaft carries a rotor assembly (coil and/or permanent magnet) of the motor 100. Because of the progressive action of the steering gear of the invention, no reduction gear is provided in the sample embodiment shown in FIG. 11. When the motor 100 is de-energized, it does not interfere with steering movements, nor with tactile feedback from the steering gear to the driver about road conditions.

In alternative embodiments, the motor 100 may be connected to the steering shaft via a reduction gear. This can be, for example, a planetary gear (epicyclic gear train), the central gear of which is formed by or is fixedly connected to the steering shaft, and the ring gear of which is fixedly connected to the rotor of the motor 100. Such a planetary gear can, for example, have a reduction ratio of 1:5 to 1:20 (preferably about 1:10), so that, when the motor 100 is de-energized, it does not, or only to a limited extent, impede feedback signals from the steering gear to the driver. In further alternative embodiments, a bevel gear or a spur gear train can be used instead of the planetary gear.

Designs such as those shown in FIG. 11 and FIG. 12, in which the prongs 50A, 50B, 50C, 70A, 70B, 70C have different sizes, allow larger torques to be transmitted at selected steering angles. These can be, for example, steering angles at which higher steering forces typically occur and/or steering angles at which a particularly high steering force assistance is provided by the motor 100. Alternatively or additionally, in embodiments with prongs 50A, 50B, 50C, 70A, 70B, 70C of different sizes, a tool with which the prong ramps 14, 16, 18 and/or the pinion elements 36, 38, 40 are produced can be optimized and/or simplified. For example, in some embodiments, the number of prongs 50A, 50B, 50C, 70A, 70B, 70C can be reduced while maintaining the same steering quality by forming the prongs in different sizes. A smaller number of prongs 50A, 50B, 50C, 70A, 70B, 70C simplifies manufacturing and requires only a less elaborate tool.

In some embodiments, the serrated component 10 can be manufactured by forging or impact extrusion or flow drawing or sintering. In particular, when forging or impact extrusion or flow drawing processes are used, the prong geometry described herein has the advantage of allowing a tool to be easily removed from the machined serrated component 10 because of the uniformity of the flank angles and their symmetrical orientation with respect to the center plane 48. This allows for more cost effective manufacturing.

In further embodiments, each serrated element 36, 38, 40 is manufactured by impact extrusion or flow drawing or punching. The individual elements 36, 38, 40 are then pressed onto the steering shaft end member 42, as illustrated in FIG. 6.

In general, the invention is not limited to the use of the above-mentioned processes, but all processes for the production of 3-dimensional bodies, with or without mechanical finishing, can be used. This includes, but is not limited to, e.g. 3D printing or precision casting.

Because of the prong shape according to the invention, in some embodiments only a relatively low surface finish quality of the prongs 20, 50 of the serrated component 10 and/or the prongs 70, 80 of the pinion component 12 is required. For example, it may be sufficient for these prongs 20, 50, 70, 80 to have a roughness called “scrupped” (Rₐ between 3.2 μm and 25 μm). In some embodiments, the roughness Rₐ may be up to 16 μm or approximately 16 μm. Such relatively high roughness can make some manufacturing processes (e.g., 3D printing without finishing) less expensive or possible in the first place. Also, a relatively large roughness has the advantage that grease adheres better to the flanks of the prongs 20, 50, 70, 80.

The details given in the above description and shown in the drawings are to be regarded not as limitations of the scope of the invention, but as examples of some embodiments of the invention. Further variations will be readily apparent to those skilled in the art. In particular, features of the embodiments described above can be combined with each other to obtain further embodiments of the invention. Accordingly, the scope of the invention is not to be defined by the described sample embodiments, but by the claims and their equivalents.

### LIST OF REFERENCES

10 serrated component
12 pinion component
14 first prong ramp
16 second prong ramp
18 third prong ramp
20 center prong (of the prong ramps)
22 base
24 side portion
26 support portion
28 pressure element
30 joint member
32 base plane
34 longitudinal direction
36 first pinion element
38 second pinion element
40 third pinion element
42 steering shaft end member
44 steering shaft bearing
46 rotation axis
48 center plane
50 prongs (of the prong ramps)
50A, 50B, 50C prongs (of the prong ramps) in FIG. 11 and FIG. 12
52 first flank
54 second flank
56 tip
58 valley
60 prong base (of the center prong 20)
62 prong base (of a prong 50)
64 inclination plane
70 prongs (of the pinion elements)
70A, 70B, 70C prongs (of the pinion elements) in FIG. 11 and FIG. 12
72 first rolling curve (of the first prong ramp)
74 second rolling curve (of the second prong ramp)
76 third rolling curve (of the first pinion element)
78 fourth rolling curve (of the second pinion element)
80 center prong (of the pinion elements in FIG. 5)
82 bearing
84 spacer
86 prong base (of the prongs of the pinion elements)
88 normal
90 angle bisector
92 center tooth (of the comparative example of FIG. 10B)
94 tooth base (of the center tooth 92 in the comparative example of FIG. 10B)
96 tooth (of the comparative example of FIG. 10B)
98 tooth base (of the tooth 96 in the comparative example of FIG. 10B)
100 motor
102 steering shaft attachment member

1. A serrated component for use in a progressive steering gear, having first and second inclined prong ramps comprising a plurality of prongs each having a first flank angle and a second flank angle with respect to a center plane that runs normal to a longitudinal direction of the serrated component, wherein, for at least 50% of the prongs of the plurality of prongs, the first flank angles have a single first angular value and the second flank angles have a single second angular value, the first angular value corresponding to a reflection of the second angular value at the center plane.

2. The serrated component according to claim 1, wherein, for at least 70% or at least 90% of the prongs of the plurality of prongs, the first flank angles have the first angular value and the second flank angles have the second angular value.

3. The serrated component according to claim 1, wherein, for at least 50% or at least 70% or at least 90% of those prongs of the plurality of prongs which have a base inclined with respect to the longitudinal direction of the serrated component, the first flank angles have the first angular value and the second flank angles have the second angular value.

4. The serrated component according to claim 1, wherein the first angle value and the second angle value for the flank angles of each prong allow a deviation of ±20%.

5. The serrated component according to claim 1, wherein the first and second angular values are x±10%, where x is a value between 25° and 40°.

6. The serrated component according to claim 1, wherein the first and second prong ramps are arranged with opposite inclinations.

7. The serrated component according to claim 1, wherein the center plane is perpendicular to a base surface of the serrated component.

8. The serrated component according to claim 1, wherein the serrated component has a center prong with a prong base that is larger than a prong base of each laterally adjacent prong.

9. The serrated component according to claim 1, wherein the first prong ramp is designed for a first rolling curve and the second prong ramp is designed for a second rolling curve, each of the rolling curves extending obliquely to the center plane and deviating, over at least 50% of its extension, by at most 10° from a rectilinear rolling curve.

10. The serrated component according to claim 1, wherein the first prong ramp is designed for a first rolling curve and the second prong ramp is designed for a second rolling curve, each of the rolling curves extending rectilinearly and obliquely to the center plane, except for deviations for correcting a running gear progression and/or a Cardan joint error.

11. The serrated component according to claim 1, wherein the first prong ramp is arranged, when viewed in side view in a viewing direction, in a plane in front of a plane of the second prong ramp.

12. The serrated component according to claim 21, wherein the serrated component comprises a third prong ramp which, in the side view, is substantially identical to the first prong ramp and is arranged, in the viewing direction, in a plane behind the planes of the first and second prong ramps.

13. The serrated component according to claim 1, wherein at least some of the prongs have different sizes.

14. A progressive steering gear comprising a serrated component according to claim 1 and a pinion component comprising a plurality of pinion elements, each of which being associated with a respective one of the prong ramps and being arranged to engage with or disengage from the associated prong ramp in dependence on a respective steering angle.

15. The steering gear according to claim 14, wherein the serrated component is adapted to be shifted substantially in the longitudinal direction.

16. The steering gear according to claim 14, wherein the serrated component is pressed against the pinion component under spring load and is movable in the direction of the center plane by at least 0.1 mm relative to the pinion component.

17. The steering gear according to claim 14, wherein each pinion element has a plurality of prongs, each with a prong base, wherein respective normals of the plurality of prongs run past the axis of rotation.

18. The steering gear according to claim 14, wherein the steering gear further comprises a motor having a motor shaft which is connected to the pinion component in a rotationally fixed manner or via a planetary gear.

19. A method of manufacturing a serrated component according to claim 1, wherein the serrated component is manufactured by forging or impact extrusion or flow drawing or sintering.

20. A method of manufacturing a steering gear according to claim 1, wherein the serrated component is manufactured by forging or impact extrusion or flow drawing or sintering, and/or in that each pinion element is manufactured by impact extrusion or flow drawing or punching.

21. The serrated component according to claim 1, wherein the first prong ramp is designed for a first rolling curve and the second prong ramp is designed for a second rolling curve, wherein each of the first and second rolling curves is non-rectilinear, and wherein the first and second rolling curves are not mirror-symmetrical with respect to each other.
